(19) United States
(12) Patent Application Publication
(10) Pub. No.: US 2014/0320035 A1
(43) Pub. Date: Oct. 30, 2014

(54) ELECTRONIC DEVICE WITH LED

(71) Applicants: HON HAI PRECISION INDUSTRY CO., LTD., New Taipei (TW); HONG FU JIN PRECISION INDUSTRY (ShenZhen)CO., LTD., Shenzhen (CN)

(72) Inventors: HAI-DONG TANG, Shenzhen (CN); KUO-PIN LIN, New Taipei (TW)

(73) Assignees: HON HAI PRECISION INDUSTRY CO., LTD., New Taipei (TW); HONG FU JIN PRECISION INDUSTRY (ShenZhen)CO., LTD., Shenzhen (CN)

(21) Appl. No.: 14/080,857

(22) Filed: Nov. 15, 2013

(30) Foreign Application Priority Data
Apr. 30, 2013 (CN) 2013101552705

(51) Int. Cl. H05B 33/08

(52) U.S. Cl. CPC H05B 33/0842
USPC 315/209 R

(57) ABSTRACT

An electronic device comprises a control unit, a power supply, a switch unit, a driving unit, and an illumination unit. The control unit generates a pulse width modulation (PWM) signal with a first level signal and a second level signal. The switch unit establishes a connection between the power supply and the driving unit or cuts off the connection in response to the PWM signal. The driving unit generates a variable driving voltage. The illumination unit emits light when the variable driving voltage is more than a first predetermine value, and the brightness of the illumination unit is gradually changed in response to the variable driving voltage.

### BACKGROUND

1. Technical Field

The present disclosure relates to electronic devices having an LED.

2. Description of Related Art

Light emitting diodes (LEDs) are widely used in different types of electronic devices. Some LEDs flash on and off to indicate different states of the electronic device. However, flashing on and off of the LEDs may irritate some users or even cause photosensitive epilepsy in others.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an embodiment of an electronic device.

FIG. 2 is a circuit diagram of the embodiment of the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at “least one.”

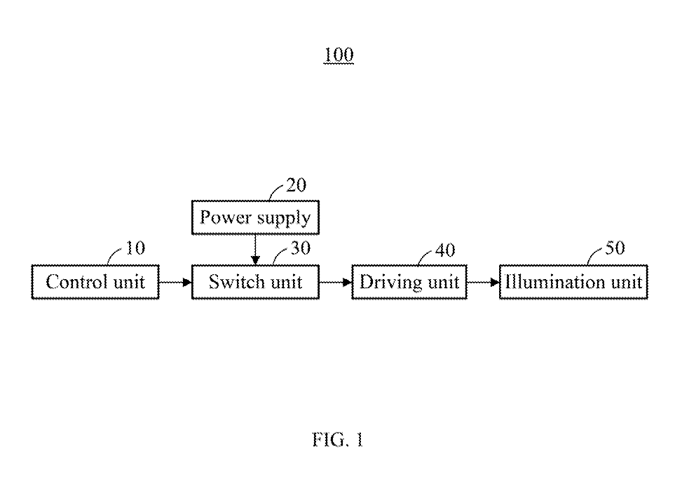

FIG. 1 shows an embodiment of an electronic device 100. The electronic device 100 includes a light emitting diode (LED) and is capable of controlling a light intensity of the LED to increase and decrease gradually. In the embodiment, the electronic device 100 is a tablet computer.

The electronic device 100 includes a control unit 10, a power supply 20, a switch unit 30, a driving unit 40, and an illumination unit 50.

The control unit 10 generates a pulse width modulation (PWM) signal. A duty ratio of the PWM signal is adjustable. The PWM signal includes a first level signal and a second level signal. In one embodiment, the first level signal is a logic-low level signal, and the second level signal is a logic-high level signal.

The power supply 20 is connected to the switch unit 30 to provide a working voltage.

The switch unit 30 is connected to the control unit 10, the power supply 20, and the driving unit 40. The switch unit 30 establishes a connection between the power supply 20 and the driving unit 40 in response to receiving the first level signal, and cuts off the connection in response to receiving the second level signal.

The driving unit 40 is connected between the switch unit 30 and the illumination unit 50. When the switch unit 30 establishes the connection between the power supply 20 and the driving unit 40, the driving unit 40 is being charged up and generates a variable driving voltage. The variable driving voltage gradually increases until the driving voltage is equal to the first predetermined value. The first predetermined value is less than the value of the working voltage provided by the power supply 20. When the switch unit 30 cuts off the connection between the power supply 20 and the driving unit 40, the driving unit 40 is being discharged and generates a variable driving voltage. The variable driving voltage gradually decrease until the driving voltage is equal to zero.

The illumination unit 50 emits light when the variable driving voltage is more than the second predetermined value. In one embodiment, the second predetermined value is 0.7V. A brightness of the illumination unit 50 is proportional to the variable driving voltage.

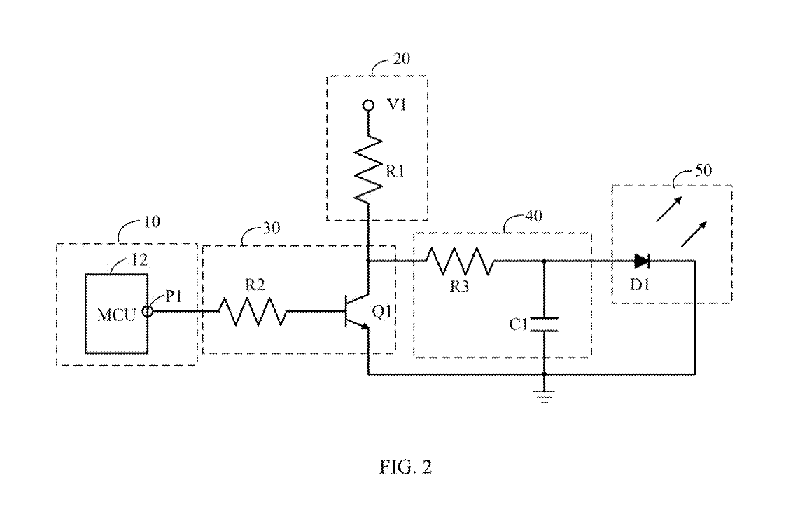

FIG. 2 shows that the control unit 10 includes a micro controller unit (MCU) chip 12. The MCU 12 includes a control pin P1.

The power supply 20 includes a power source V1 and a protection resistor R1. The protection resistor R1 is connected between the power source V1 and the switch unit 30.

The switch unit 30 includes a first resistor R2 and a transistor Q1. The transistor Q1 is connected to the protection resistor R1 of the power supply 20. A base of the transistor Q1 is connected to the control pin P1 through the resistor R2. An emitter of the transistor Q1 is grounded. A collector of the transistor Q1 is connected to the power source V1 through the protection resistor R1. In one embodiment, the transistor Q1 is an npn-type bipolar junction transistor.

The driving unit 40 includes a second resistor R3 and a capacitor C1. One terminal of the capacitor C1 is connected to the collector of the first transistor Q1 through the second resistor R3, and another terminal of the capacitor C1 is grounded.

The illumination unit 50 includes a diode D1. A cathode of the diode D1 is grounded. An anode of the diode D1 is connected to the collector of the first transistor Q1 through the third resistor R3. In the embodiment, the diode D1 is an LED. In other embodiments, the illumination unit 50 can be a plurality of LEDs or other light emitting elements.

A working method of the protection circuit 300 is described as follow. The control pin P1 outputs the first level signal to make a voltage different between the base and the emitter of the transistor Q1 be less than 0.7V, which causes the transistor Q1 to turn off and the capacitor C1 to be charged directly by a voltage of the power source V1. When the capacitor C1 is charged directly by the power source V1, a voltage at the anode of the diode D1 gradually increases. When a voltage difference between the anode and the cathode of the diode D1 is more than 0.3V, the diode D1 turns on and emits light. A brightness of the diode D1 gradually increases until the capacitor C1 is completely charged.

The control pin P1 outputs the second level signal to make the voltage different between the base and the emitter of the transistor Q1 be more than 0.7V, which causes the transistor Q1 to turn on and the capacitor C1 to be discharged. When the capacitor C1 discharges, the voltage at the anode of the diode D1 gradually decreases, which cause the brightness of the diode D1 to gradually decrease. When the voltage difference between the anode and the cathode of the diode D1 is less than 0.3V, the diode D1 turns off and stops emitting light.

In a first embodiment, the control unit 10 firstly adjusts the duty ratio of the PWM signal to gradually increase the brightness of the diode D1 until the capacitor C1 is completely charged.

In a second embodiment, the diode D1 is firstly turned on based on the variable driving voltage, then the control unit 10 adjusts the duty ratio of the PWM signal to gradually decrease the brightness of the diode D1 until the diode D1 turns off.

In a third embodiment, the control unit 10 adjusts the duty ratio of the PWM signal to control the brightness of the diode D1 to switch between gradually increasing and gradually decreasing.

In use, the brightness of the LED increases and decreases gradually, which reduces irritation on eyes of a user.

It is to be understood, however, that even though information and advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device comprising:
a control unit for generating a pulse width modulation (PWM) signal with a first level signal and a second level signal;
a power supply for providing a working voltage;
a driving unit for generating a variable driving voltage;
a switch unit capable of establishing a connection between the power supply and the driving unit or cutting off the connection in response to the PWM signal; and
a illumination unit for emitting light when the variable driving voltage is more than a first predetermine value;
wherein the driving voltage outputted by the driving unit is changed gradually for adjusting the brightness of the illumination unit.

2. The electronic device of claim 1, wherein the switch unit establishes the connection when the PWM is in the first level signal, and cuts off the connection when the PWM signal is in the second level signal; the driving unit further charges when the connection is established, and discharges when the connection is cut off.

3. The electronic device of claim 2, wherein the control unit adjusts a duty ratio of the PWM signal to control the variable driving voltage to gradually increase, when the driving voltage is equal to a second predetermined value, the variable driving voltage remains at the second predetermined value; the brightness of the illumination unit gradually increases in response to the variable driving voltage.

4. The electronic device of claim 3, wherein when the illumination unit emits light, the control unit further adjusts the duty ratio of the PWM signal to control the variable driving voltage to gradually decrease, the brightness of the illumination unit gradually decreases.

5. The electronic device of claim 2, wherein the control unit adjusts the duty ratio of the PWM signal to control the driving unit to output a variable driving voltage, the variable driving voltage controls the brightness of the illumination unit to switch between gradually increasing and gradually decreasing.

6. The electronic device of claim 1, wherein the switch unit comprises a first resistor and a transistor; a base of the transistor is connected to the control unit through the resistor; an emitter of the transistor is grounded; a collector of the transistor is connected to the power supply.

7. The electronic device of claim 6, wherein the transistor is an npn type bipolar junction transistor.

8. The electronic device of claim 1, wherein the driving unit comprises a second resistor and a capacitor; one terminal of the capacitor is connected to the switch unit through the second resistor, and another terminal of the capacitor is grounded.
